(19) United States
(12) Patent Application Publication
(10) Pub. No.: US 2019/0301361 A1
(43) Pub. Date: Oct. 3, 2019

(54) FUEL-AIR INJECTION ROTARY ENGINE

(71) Applicant: Kan Cheng, Newark, CA (US)

(72) Inventor: Kan Cheng, Newark, CA (US)

(21) Appl. No.: 15/937,833

(22) Filed: Mar. 27, 2018

(51) Int. Cl. F02B 53/10; F01C 21/00; F01C 21/04; F02B 75/02; F02M 23/04; F02D 41/00

(52) U.S. Cl. CPC F02B 53/10; F01C 21/001; F01C 21/04; F02B 75/02; F01C 1/22; F02D 41/0025; F02D 2200/025; F02D 2250/36; F02M 23/04

(57) ABSTRACT

A FAIR engine system includes an air compressor subsystem where oxygen enriched air is compressed, stored and injected into the chambers of a FAIR engine to accelerate the chemical reaction and to reduce harmful mono-nitrogen oxides (NOx) emission

### TECHNICAL FIELD

The present invention generally relates to a rotary internal combustion engine, and more particularly to a Wankel rotary engine. Further, the present invention relates to a method of fuel-air injection to the above rotary internal combustion engine and Wankel engine comprising the same.

### BACKGROUND

Wankel rotary engine delivers advantages of simplicity, smoothness, compactness, high revolutions per minute, and a high power-to-weight ratio. However, with a unique structure it also has many disadvantages such as apex wear out, slow combustion due to narrow-shaped combustion chamber, poor fuel economy and high emissions.

### SUMMARY OF THE INVENTION

Fuel-Air Injection Rotary (refer to as FAIR) engine is a structure advancement over conventional Wankel engine. It replaces the air compression mechanism of a Wankel engine with a secondary combustion mechanism in addition to the existing one, so a FAIR engine operates with two combustion cycles and delivers two power strokes per shaft revolution versus a Wankel engine which operates with one combustion cycle and delivers one power stroke per shaft revolution.

Combustion of FAIR engine depends on fuel and air injections. FAIR engine implements Oxygen Enriched Compressed Air (OECA) injection to accelerate the chemical reaction for thorough combustion and emission reduction. Fuel is injected before the air injection and spark plug ignites the mixture, the combustion depends on air injection and independent to fuel property; various fuel types can be used.

### BRIEF DESCRIPTION OF THE DRAWINGS

FIG. 1 shows an expanded view of a FAIR engine embodiment with an engine housing, a triangle shaped rotor, an eccentric shaft (shaft), a stationary gear, a front cover and a back cover in accordance with an embodiment.

FIG. 2 shows a FAIR engine with two lubricating oil injectors (oil injectors), two fuel injectors, two air injectors, two spark plugs, two exhaust ports, a triangle shaped rotor (rotor), three rotational combustion chambers (chamber), a shaft and a stationary gear in accordance with an embodiment.

FIG. 3 shows a 360° polar coordinate overlay atop of an engine housing and alpha numerical references overlay atop of the rotor at the edge and the apex in accordance with an embodiment.

FIG. 4 shows rotational positions of the rotor in relation to engine housing at 15°, 30°, 180° in accordance with an embodiment.

FIG. 5 shows rotational positions of the rotor in relation to engine housing at 195°, 210°, 0° in accordance with an embodiment.

FIG. 6 shows an engine vibration amplitude comparison diagram in time domain at the engine housing in accordance with an embodiment.

FIG. 7 shows a FAIR engine system diagram including peripherals in accordance with an embodiment.

### DESCRIPTION OF THE EMBODIMENTS

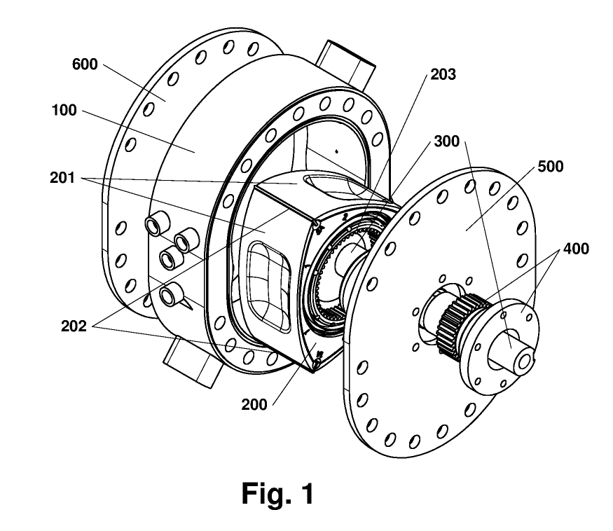

FIG. 1 represents an engine housing 100 with an epitrochoid shaped inner wall, a reuleaux triangle shaped rotor 200, a shaft 300, a stationary gear 400, a front cover 500 and a back cover 600. The rotor comprises three rotor surfaces 201 around the rotor, three sealing apexes 202 at rotor tips and an inner gear 203 inside the rotor body. The rotor rotating clockwise around the shaft with its inner gear constrained by the stationary gear and the stationary gear is mounted on the front cover.

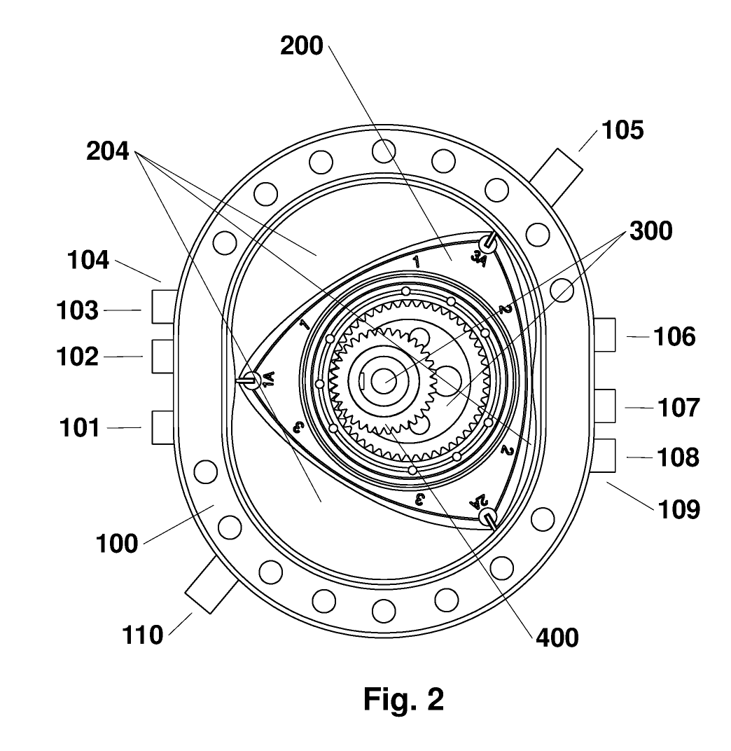

FIG. 2 represents a side view of the FAIR engine with two injection groups. Injection group 1 comprises an oil injector-1 101, a fuel injector-1 102, an air injector-1 103; behind the air injector, a spark plug-1 104 and an exhaust port-1 105. Injection group 1 executes combustion process within upper half of the engine housing. On the opposite side of the engine housing, injection group 2 comprises an oil injector-2 106, a fuel injector-2 107, an air injector-2 108; behind the air injector, a spark plug-2 109 and an exhaust port-2 110. Injection group 2 executes combustion process within lower half of the engine housing. The rotor rotating around the shaft with its inner gear constrained by the stationary gear; the inner wall of the engine housing, three apexes, three rotor surfaces, front and back cover to encapsulate three rotational chambers 204.

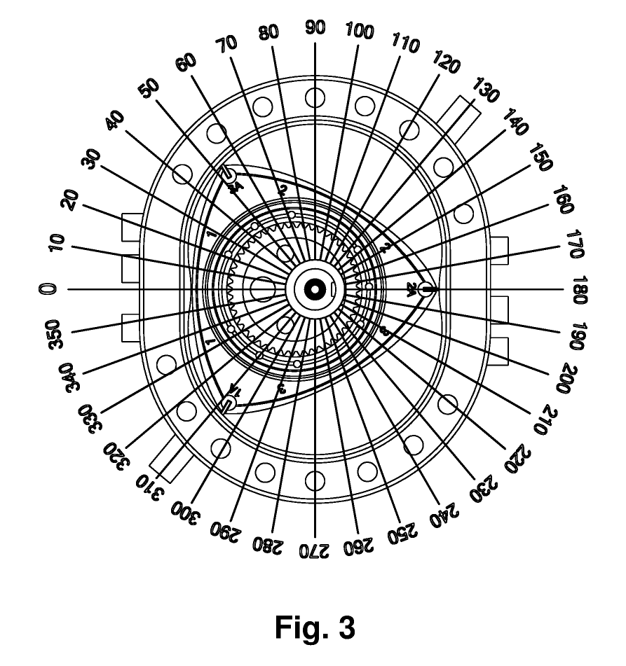

FIG. 3 implements a polar coordinate overlay atop the engine housing to reference components, rotor surfaces and chambers position. For example, FIG. 3 shows fuel injector-1 is at 15°. Rotor surfaces are referenced by alpha numerical marks on the edges of the rotor and each chamber position is defined by the normal line of associated rotor surface. For example, chamber 1 is at 0°.

What follows is a description of principles of operation,

The inner gear of the rotor has a 3:1 ratio to the stationary gear, a 180° rotation of the shaft is in synchronizing with a 60° rotation of the rotor and associated chambers. Table 1 represents status change of chambers at active positions. Column 1 indicates the position where chambers change state. Column 2 indicates figures in relation to column 1 positions. Column 3, 4, 5 describe thermal status of chambers.

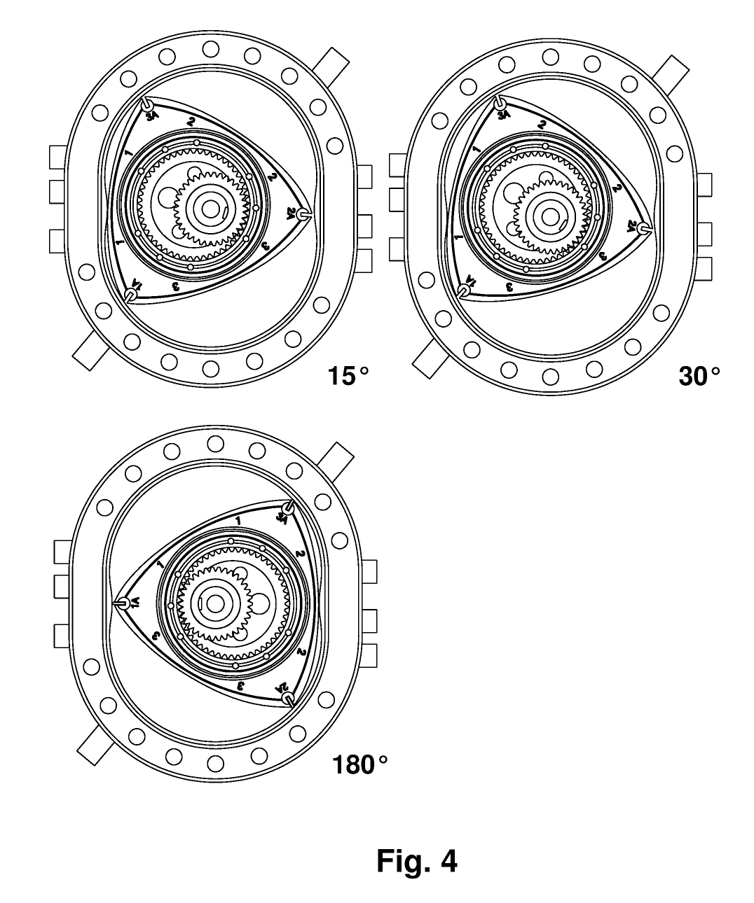

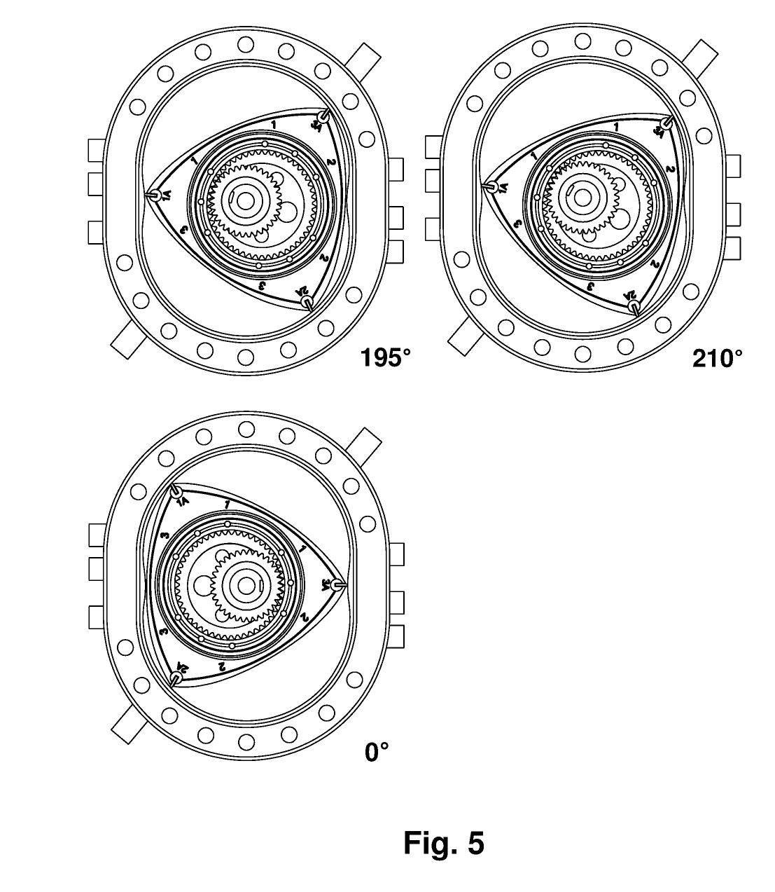

TABLE 1
Status change of combustion chambers

| Active | | Combustion | Combustion | Combustion |
|---|---|---|---|---|
| Positions | FIGS. | Chamber 1 | Chamber 2 | Chamber 3 |
| 15° | FIG. 4-15° | Fuel | Exhaust-1 | Exhaust-2 |
| | | Injection-1 | | |
| 30° | FIG. 4-30° | Air | Exhaust-1 | Exhaust-2 |
| | | Injection-1 | | |
| 180° | FIG. 4-180° | End | Exhaust-1 | Exhaust-2 |
| | | expansion-1 | | |
| 195° | FIG. 5-195° | Exhaust-1 | Fuel | Exhaust-2 |
| | | | Injection-2 | |
| 210° | FIG. 5-210° | Exhaust-1 | Air | Exhaust-2 |
| | | | Injection-2 | |
| 0° | FIG. 5-0° | Exhaust-1 | End | Exhaust-2 |
| | | | expansion-2 | |

FIG. 4—15° indicates chamber 1 went through a final stage of an exhaust cycle at 0° then rotates to 15°, oil injector-1 and fuel injector-1 are activated simultaneously, injected oil towards to upcoming apex and injected fuel is not able to combust without enough oxygen, fuel particles absorb heat for evaporation and expansion. Fuel injection-1 cycle ends at 30°.

FIG. 4—30° indicates chamber 1 rotates to 30°, air injector-1 and spark plug-1 are activated simultaneously, high pressure air mixes with fuel vapor, the combustion is ignited by spark plug-1. Air injection-1 cycle may be ended at any position between 30° to 60° before the exhaust cycle starts.

FIG. 4—180° indicates two activities, chamber 1 rotates to 60° and chamber 2 rotates to 180°. At 60° chamber 1 is entering to exhaust port-1, at 180° chamber 2 is at a final stage of an exhaust cycle and exiting exhaust port-1. At this point the rotor rotated 60° and shaft rotated 180°.

FIG. 5—195° indicates chamber 2 rotates to 195°, oil injector-2 and fuel injector-2 are activated simultaneously, injected oil towards to upcoming apex and injected fuel is not able to combust without enough oxygen, fuel particles absorb heat for evaporation and expansion. Fuel injection-2 cycle ends at 210°.

FIG. 5—210° indicates chamber 2 rotates to 210°, air injector-2 and spark plug-2 are activated simultaneously, high pressure air mixes with fuel vapor, the combustion is ignited by spark plug-2. Air injection-2 cycle may be ended at any position between 210° to 240° before the exhaust cycle starts.

FIG. 5—0° indicates two activities, chamber 2 rotates to 240° and chamber 3 rotates to 0°. At 240° chamber 2 is entering to exhaust port-2, at 0° chamber 3 is at a final stage of an exhaust cycle and exiting exhaust port-2. At this point the rotor rotated 120° and shaft rotated 360°, a new shaft revolution begins.

Oil and fuel injections are also known as maintenance cycles, the injected oil lubricates the apexes and injected fuel brings down the temperature of apexes and rotor tips. Fuel can be in liquid or gas phase such as alcohol, gasoline, diesel, methane or propane. FAIR engine may use local produced fuel for better fuel economy, fuel sources could be switched manually or automatically during engine operation time depending on fuel tank sensor status. The controller computer (computer) holds a look up table in controlling the amount of injected fuel and air mixture to match the stoichiometric ratio and power output.

In regards to air injections, rotary engine in general has narrow shaped chamber which causes slow combustion and emission problems. FAIR engine implements Oxygen Enriched Compressed Air (OECA) injection to accelerate the chemical reaction of fuel combustion, the injected OECA not only enhancing combustion, but also reducing harmful mono-nitrogen oxide (NOx) emission and increasing the carried oxygen density within the air tank.

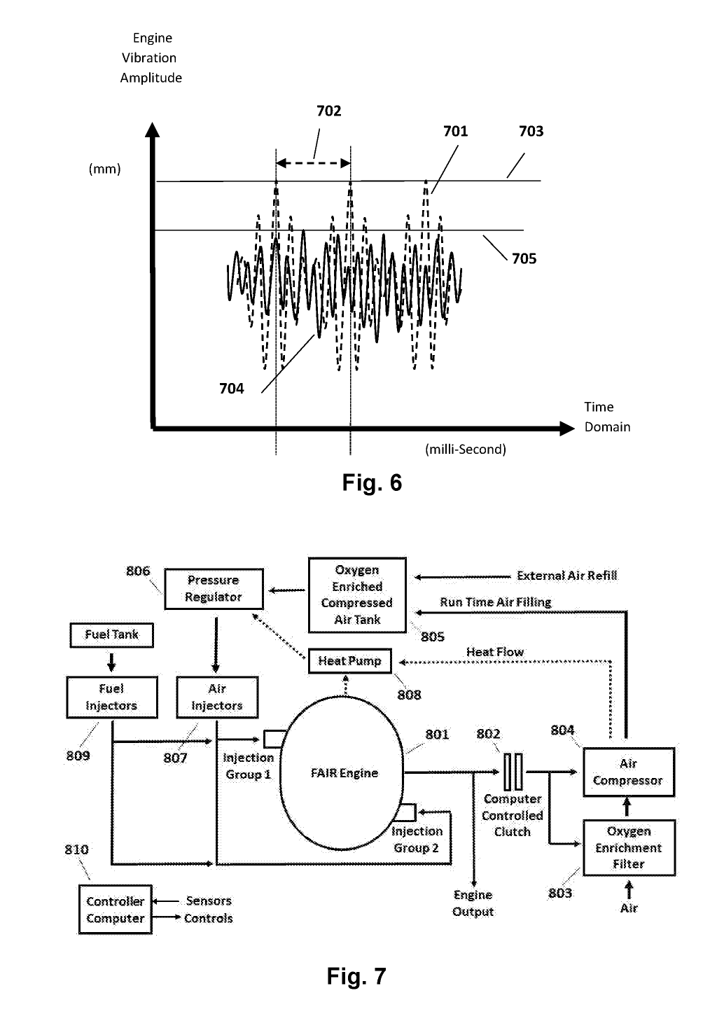

FIG. 6 represents the engine vibration amplitude in time domain, a dotted curve 701 represents the engine vibration amplitude with resonance, 702 indicates the period of the resonance and 703 indicates amplitude peaks with resonance. A solid curve 704 represents random vibration without resonance and 705 indicates the peak amplitude without resonance. When sensor detects abnormal resonant vibration, the computer may generate a random time variation to the ignition timing, the combustion timing modulation can break down the vibration period and resonance. Same process may be used to break down the resonant noises generated in the exhausting system. If random modulation to be replaced by coded modulation, then combustion noises may use air or water as the media to transmit data between nearby vehicles.

FIG. 7 represents a FAIR engine system diagram, engine 801 has two major loads, the main shaft output and the air compressor subsystem. Air compressor subsystem connects to the engine shaft through a computer-controlled clutch (clutch) 802, the output side of the clutch drives an oxygen enrichment filter device 803 and a high-pressure air compressor 804 (compressor). Oxygen enriched air is fed to the compressor, air pressure produced by the compressor is at about 300 bar, it is stored in the Oxygen Enriched Compressed Air (OECA) tank 805. OECA is fed to a pressure regulator 806 and regulated air is fed to air injectors 807 at about 40 bar, it is higher than the combustion generated pressure at about 20 to 30 bar. Air expansion absorbs heat at the pressure regulator when pressure drops from 300 bar to 40 bar, a heat pump 808 is used to pump heat from the engine and compressor to the air pressure regulator.

When pressure sensor detects pressure low of the OECA tank, the computer 810 may connect the clutch to generate OECA and filling up the tank. Else, when computer receives power demand, the software has the option to disconnect the clutch and offload the air compressor subsystem to increase the net output power as long as the pressure in OECA tank remains. With sealable air intake and “U” shape exhaust pipe, FAIR engine may be operated under water with stored OECA, the stored OECA also may be used for life support.

To start the engine, the computer disconnects the clutch and disable fuel injectors 809, the air injection pushes the rotor to one of the injection group position, then the normal combustion procedures start the engine with fuel-air injection and ignition.

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope, which is set forth in the following claims.

What is claimed is:

1. A FAIR engine comprising:
an engine housing;
a shaft;
a rotor with inner gear;
a stationary gear;
a front cover;
a back cover;
three rotational chambers;
two injection groups, each comprising:
an air injector;
a fuel injector;
a spark plug;
an oil injector;
an exhaust port;
wherein, said rotary engine executes two combustion cycles per shaft revolution with 180° phase difference between each cycle.

2. A rotary engine as in claim 1 wherein injection groups, fuel injection is activated before the air injection, combustion depends on air injection and spark plug ignition and independent to fuel property.

3. A rotary engine as in claim 2 additionally comprising: injected fuel brings down the temperature of apexes and rotor tips.

4. A rotary engine as in claim 2 additionally comprising: engine may switch fuel sources with different fuel property during engine operation time.

5. A rotary engine as in claim 1 wherein injection groups, the air injection and spark ignition timing modulation are used to break down the engine resonant vibration.

6. A rotary engine as in claim 5 additionally comprising: the air injection and spark ignition timing modulation is used to break down the audio resonance established in the exhaust system.

7. A rotary engine as in claim 5 additionally comprising: the air injection and spark ignition timing modulation is used to encode the exhaust noises into communication signals and broadcast the encoded noises into surrounding media such as air or water for communications.

8. A FAIR engine system, comprising:
a FAIR engine;
an air compressor subsystem, which comprising:
an oxygen enrichment filter;
a compressor;
an OECA reservoir tank;
an air pressure regulator;
a heat pump;
two air injectors;
two fuel injectors;
a computer;
a computer-controlled clutch;
wherein in the air compressor subsystem, oxygen enriched air is compressed, stored and injected into the chambers of the FAIR engine to accelerate the chemical reaction and to reduce harmful mono-nitrogen oxides (NOx) emission.

9. A FAIR engine system as in claim 8 additionally comprising: the air pressure regulator being used as a cold reservoir to sink the heat generated by the engine and the compressor, a heat pump may be used to accelerate the heat transfer.

10. A FAIR engine system as in claim 8 wherein computer-controlled clutch, engine output power is increased by disconnecting the clutch and offload the air compressor subsystem.

11. A FAIR engine system as in claim 10 additionally comprising: stored OECA may be consumed by engine for air independent propulsion as long as air tank pressure maintains.

12. A FAIR engine system as in claim 10 additionally comprising: with clutch disconnected and fuel injectors deactivated, air injection pushes the rotor to nearest injection group position then starts the engine with normal procedures.

13. A FAIR engine system as in claim 8 wherein computer-controlled clutch, engine drives the air compressor subsystem with clutch connected to generate OECA to refill the OECA reservoir tank

14. A FAIR engine system wherein air compressor subsystem, oxygen enriched air is compressed, stored and injected into the chambers of a FAIR engine to accelerate the chemical reaction and to reduce harmful mono-nitrogen oxides (NOx) emission.
